(19) United States
(12) Patent Application Publication
(10) Pub. No.: US 2006/0226173 A1
(43) Pub. Date: Oct. 12, 2006

(54) Closure arrangement

(76) Inventor: Jacobus Adriaan Wessels, Loevenstein (ZA)

Correspondence Address: STITES & HARBISON PLLC, 1199 NORTH FAIRFAX STREET, SUITE 900, ALEXANDRIA, VA, 22314, US

(21) Appl. No.: 10/553,224

(22) PCT Filed: Apr. 14, 2004
(86) PCT No.: PCT/IB04/50440

§ 371 Date: Oct. 14, 2005

(30) Foreign Application Priority Data
Apr. 17, 2003 (ZA) 2003/3025

(51) Int. Cl. G01F 11/00

(52) U.S. Cl. 222/219

(57) ABSTRACT

The invention discloses a closure arrangement (20) including a locating member (24) being adapted to be joined to a neck of a container. A dispensing body (22) encloses the locating member (24) and is uni-directionally rotatably joined thereto. The locating member (24) has an internal thread (52) and the dispensing body (22) is nonrotatable about the locating member (24) in a direction required to screw the locating member (24) onto a neck of a container, while the dispensing body (22) is freely rotatable about the locating member (24) in a direction required to screw the locating member (24) off a neck of a container, thereby preventing removal of the locating member (24) from the container. The dispensing body (22) includes a spigot (26) movably joined to the body (22), and a control member (28) movably associated with the spigot (26). The body (22) defines a centrally located cylindrical bore (30) across which a first passage (32) extends traversing the bore (30) along its diameter. The first passage (32) has an inlet (34) and an outlet (36).

### FIELD OF INVENTION

The present invention relates to a closure arrangement.

More particularly, the invention relates to a closure arrangement and valve unit for dispensing flowable materials.

### BACKGROUND TO INVENTION

It is often desirable to obtain a fixed volume of substance out of a container, such as a tube or bottle. This is especially the case in medical applications such as medicines or salves. When working with liquids, a fixed volume can be relatively easily measured off in a syringe or a measuring cup. As an aid in dispensing fixed volumes and in order to reduce the likelihood of spillage, a number of measuring caps have been developed for attachment on containers.

Many measuring caps have an inherent defect in that the cap can be relatively easily removed from a container, which allows indeterminate amounts of a substance to be withdrawn from the container. A child could thus innocently consume dangerous or toxic amounts of a medicine contained inside the container.

It is an object of the invention to suggest a closure arrangement, which will assist in overcoming the abovementioned problems.

### SUMMARY OF INVENTION

According to the invention, a closure arrangement includes a locating member being adapted to be joined to a neck of a container; and a dispensing body enclosing the locating member and being uni-directionally rotatably joined to the locating member.

The locating member may have an internal thread with the dispensing body being non-rotatable about the locating member in a direction required to screw the locating member onto a neck of a container.

The dispensing body may be freely rotatable about the locating member in a direction required to screw the locating member off a neck of a container.

The closure arrangement may include a ratchet mechanism operatively provided between the locating member and the dispensing body.

The ratchet mechanism may include at least one ratchet wheel protrusion extending from the dispensing body for engagement with at least one pawl extending from the locating member, or lice versa.

The locating member may be interchangeable within the dispensing body prior to attachment to a container, each different locating member having differing screw threads being adapted to fit different containers, thereby allowing each locating member to act as a universal adaptor so that the dispensing body is joinable to a number of different containers.

The dispensing body may be provided with an outlet being adapted to dispense discrete volumes of a substance contained in the container.

The dispensing body may include:
a) a dispenser body having a dispenser inlet and a dispenser outlet;
b) a metering chamber, having a predetermined volume and two chamber openings, being movably located inside the dispenser body in a manner allowing at least one of the chamber openings to be moved between a first position where it is in alignment with the dispenser inlet and a second position where it is alignment with the dispenser outlet; and
c) a control member movably located inside the metering chamber between the chamber openings and being adapted to selectively dose off the dispenser outlet

The dispensing body may include:
a) a body;
b) a movable member movably associated with the body,
c) a first passage extending through the body;
d) a second passage extending through the movable member, the movable member being adapted to align the second passage with the first passage; and
e) a control member movably located inside the second passage, the control member being adapted to regulate the filling of and the exhausting of a flowable substance from the second passage through the first passage.

The dispensing body may include a locking latch being adapted to removably engage with the movable member to prevent movement thereof

The invention also extends to a container provided with a closure arrangement as set out herein.

### BRIEF DESCRIPTION OF DRAWINGS

The invention will now be described by way of example with reference to the accompanying schematic drawings.

In the drawings there is shown in:

FIG. 1 a perspective view of a valve unit in accordance with the invention;

FIG. 2 an exploded perspective view of the valve unit shown in FIG. 1;

FIG. 3 a sectional side view of the valve unit seen along arrows III-III in FIG. 1; and

FIG. 4 a sectional side view of the valve unit seen along arrows IV-IV in FIG. 3.

### DETAILED DESCRIPTION OF DRAWINGS

Referring to the drawings, a closure arrangement in accordance with the invention, generally indicated by reference numeral 20, is shown. The closure arrangement 20 includes a cap or dispensing body 22, which is rotatably joined to a locating member 24 for attachment to a container (not shown) such as a tube of paste. The dispensing body 22 fully encloses the locating member 24 to prevent a user from gripping the locating member directly.

The dispensing body 22 includes a spigot 26 movably joined to the body 22, and a control member 28 movably associated with the spigot 26. The body 22 defines a centrally located cylindrical bore 30, across which a first passage 32 extends traversing the bore 30 along its diameter. The first passage 32 has an inlet 34 and an outlet 36.

The spigot 26 is cylindrical in shape having an external diameter which is substantially similar to the diameter of the bore 30, with the spigot 26 being rotatably located within the bore 30. A second passage 38, which has a diameter slightly larger than the diameter of the first passage 32, extends through the spigot 26, the second passage 38 having openings on opposite sides of a diameter of the spigot 26. Thus, when the spigot 26 is located in the bore 30, the second passage 38 can be aligned with the first passage 32 by suitably rotating the spigot 26. The body 22 and the spigot 26 can have a ratchet interaction for assisting in aligning the first passage 32 and second passages 38 during use.

A protruding gripping member 40 extends from the spigot 26 to enable easy rotation of the spigot 26 inside the bore 30.

The control member 28 is a spherical ball having a diameter substantially similar to a diameter of the second passage 38 and larger than a diameter of the first passage 32.

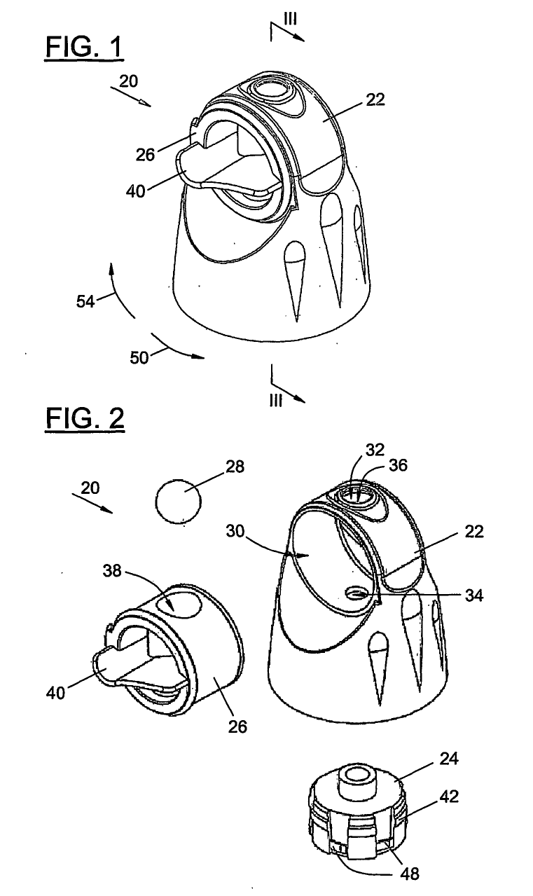

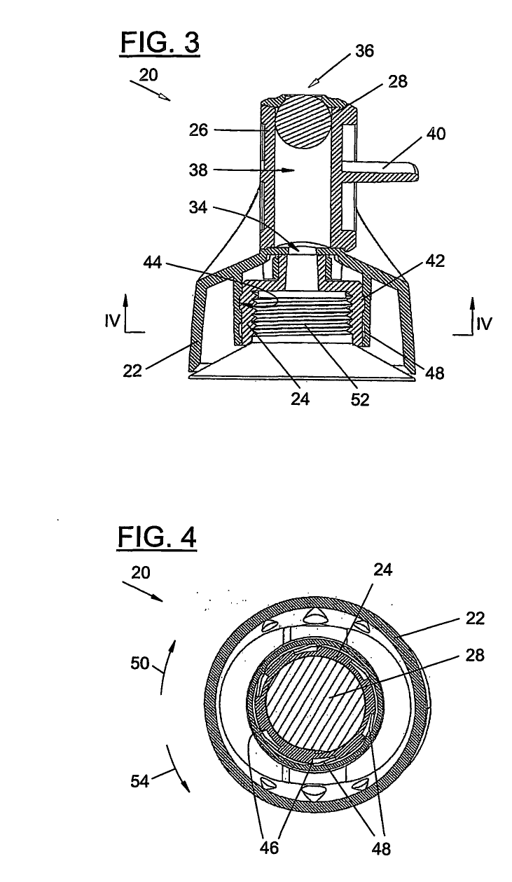

The locating member 24 is rotatably joined to the dispensing body 22 by an intermittently broken, annular ridge 42 extending outwardly from the locating member 24, which ridge 42 is receivable in a groove 44 provided in the dispensing body 22. A unidirectional ratchet mechanism, formed by ratchet wheel protrusions 46 extending from the dispensing body 22 and engaging with pawls 48 extending from the locating member 24, allows the dispensing body 22 to rotate around the locating member in one direction only, as indicated by arrow 50 in FIGS. 1 and 4.

The locating member 24 has an internal screw thread 52 for attaching the closure arrangement 20 to a container, such as a tube of paste. The screw thread 52 can be adapted to fit a variety of container threads so that the locating member 24 acts as an adaptor allowing the dispensing body 22 to be joinable to a variety of different containers.

In use, the closure arrangement 20 is screwed onto a container by turning the closure arrangement 20 in a normal clockwise direction indicated by arrow 54 so that the thread 52 of the locating member 24 screws onto a thread of the container. The pawls 48 engage with the ratchet wheel protrusions 48 to prevent rotation of the dispensing body 22 relative to the locating member 24 and thus allowing tightening of the closure arrangement 20 onto the container.

Once properly tightened, the friction resistance between the thread 52 and the thread of the container ensures that the locating member 24 is securely joined to the container. Furthermore, as the locating member 24 is fully enclosed by the dispensing body 22, the locating member 24 cannot be gripped for removal purposes. Any counter clockwise turning of the dispensing body 22 merely results in the dispensing body 22 rotating around the locating member 24 as the pawls 48 do not engage with but deflect over the ratchet wheel protrusions 48. Thus, once attached, the closure arrangement 20 cannot be removed from the container without partial or complete destruction of the dispensing body 22.

The contents of the container can be expressed in discrete volumes through the closure arrangement 20. The spigot 26 is rotated so that the first and second passages 32, 38 are in alignment and with the ball or control member 28 lying closest to the inlet 34. By pressing the container, a first volume of paste is expressed through the inlet 34 into the second passage 38 and simultaneously forcing the ball 28 towards the outlet. Once the ball 28 reaches the outlet 36 and abuts against the dispensing body 22, the second passage 38 is filled with the paste, and no further paste can be expressed from the container.

The spigot 26 is then rotated through one hundred and eighty degrees (180°) relative to the dispensing body 22 until the first and second passages 32, 38 are again aligned. The ball 28 thus abuts against the dispensing body 22 near to the inlet 34 of the first passage 32.

Finally, the first volume of paste is exhausted from the dispensing body 22 by expressing a further volume of paste into the second passage 38. As the second volume of paste enters the second passage 38, it moves the ball 28 until it again abuts against the dispensing body 22 near the outlet 36. Simultaneously, the ball 28 acts to exhaust the first volume of paste from the second passage 38.

Additional volumes of paste can be obtained by repeating the above steps as often as required.

A locking latch (not shown) can be provided in the dispensing body 22 for removable engagement with the spigot 26 to prevent movement thereof.

The closure arrangement 20 thus provides additional safety for children. As only discrete volumes of paste can be expressed at a time and as a certain amount of dexterity is required to rotate the spigot 26, it is unlikely that a child could obtain sufficient quantities of paste for it to be harmful or toxic. A child will normally also have insufficient strength to destroy the dispensing body 22 for removal of the closure arrangement 20 from the container.

1. A closure arrangement including a locating member being adapted to be joined to a neck of a container; and a dispensing body enclosing the locating member and being uni-directionally rotatably joined to the locating member.

2. A closure arrangement as claimed in claim 1, in which the locating member has an internal thread and the dispensing body is non-rotatable about the locating member in a direction required to screw the locating member onto a neck of a container.

3. A closure member as claimed in claim 2, in which the dispensing body is freely rotatable about the locating member in a direction required to screw the locating member off a neck of a container.

4. A closure arrangement as claimed in claim 1, which includes a ratchet mechanism operatively provided between the locating member and the dispensing body.

5. A closure arrangement as claimed in claim 4, in which the ratchet mechanism includes at least one ratchet wheel protrusion extending from the dispensing body for engagement with at least one pawl extending from the locating member, or vice versa,.

6. A closure arrangement as claimed in claim 1, in which the locating member is interchangeable within the dispensing body prior to attachment to a container, each different locating member having differing screw threads being adapted to fit different containers, thereby allowing each locating member to act as a universal adaptor so that the dispensing body is joinable to a number of different containers.

7. A closure arrangement as claimed in claim 1, in which the dispensing body is provided with an outlet being adapted to dispense discrete volumes of a substance contained in the container.

8. A closure arrangement as claimed in claim 1, in which the dispensing body includes:
a) a dispenser body having a dispenser inlet and a dispenser outlet;
b) a metering chamber, having a predetermined volume and two chamber openings, being movably located inside the dispenser body in a manner allowing at least one of the chamber openings to be moved between a first position where it is in alignment with the dispenser inlet and a second position where it is alignment with the dispenser outlet; and
c) a control member movably located inside the metering chamber between the chamber openings and being adapted to selectively close off the dispenser outlet.

9. A closure arrangement as claimed in claim 1, in which the dispensing body includes:
a) a body;
b) a movable member movably associated with the body;
c) a first passage extending through the body;
d) a second passage extending through the movable member, the movable member being adapted to align the second passage with the first passage ; and
e) a control member movably located inside the second passage, the control member being adapted to regulate the filling of and the exhausting of a flowable substance from the second passage through the first passage.

10. A closure arrangement as claimed in claim 9, in which the dispensing body includes a locking latch being adapted to removably engage with the movable member to prevent movement thereof.

11. A container provided with a closure arrangement as claimed in claim 1.

12. (canceled)

13. A closure arrangement including a locating member being adapted to be screw joined to a threaded neck of a container; a dispensing body enclosing the locating member and being uni-directionally rotatably joined to the locating member; and a ratchet mechanism associated with the dispensing body causing the dispensing body to be freely rotatable about the locating member in a direction required to screw the locating member off a neck of a container and further causing the dispensing body to be non-rotatable about the locating member in a direction required to screw the locating member onto a neck of a container.

14. A closure arrangement as claimed in claim 13, which includes a ratchet mechanism operatively provided between the locating member and the dispensing body.

15. A closure arrangement as claimed in claim 14, in which the ratchet mechanism includes at least one ratchet wheel protrusion extending from the dispensing body for engagement with at least one pawl extending from the locating member, or vice versa.

16. A closure arrangement as claimed in claim 13, in which the locating member is interchangeable within the dispensing body prior to attachment to a container.

17. A closure arrangement as claimed in claim 16, in which each different locating member has unique screw threads being adapted to fit threaded necks of different containers, thereby allowing each locating member to act as a universal adaptor so that the dispensing body is joinable to a number of different containers.

18. A closure arrangement as claimed in claim 13, in which the dispensing body is provided with an outlet being adapted to dispense discrete volumes of a substance contained in the container.

19. A closure arrangement as claimed in claim 13, in which the dispensing body includes:
a) a dispenser body having a dispenser inlet and a dispenser outlet;
b) a metering chamber, having a predetermined volume and two chamber openings, being movably located inside the dispenser body in a manner allowing at least one of the chamber openings to be moved between a first position where it is in alignment with the dispenser inlet and a second position where it is alignment with the dispenser outlet; and
c) a control member movably located inside the metering chamber between the chamber openings and being adapted to selectively close off the dispenser outlet.

20. A closure arrangement as claimed claim 13, in which the dispensing body includes:
a) a body;
b) a movable member movably associated with the body;
c) a first passage extending through the body;
d) a second passage extending through the movable member, the movable member being adapted to align the second passage with the first passage; and
e) a control member movably located inside the second passage, the control member being adapted to regulate the filling of and the exhausting of a flowable substance from the second passage through the first passage.

21. A closure arrangement as claimed in claim 20, in which the dispensing body includes a locking latch being adapted to removably engage with the movable member to prevent movement thereof.
